(19) United States
(12) Patent Application Publication
(10) Pub. No.: US 2008/0191692 A1
(43) Pub. Date: Aug. 14, 2008

(54) Actuating Means

(76) Inventor: Frank Buerger, Dueren (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/792,594

(22) PCT Filed: Dec. 6, 2005
(86) PCT No.: PCT/EP05/56510

§ 371 Date: Dec. 17, 2007

(30) Foreign Application Priority Data
Dec. 23, 2004 (DE) 10 2004 062 098.9

(51) Int. Cl. G01D 5/12

(52) U.S. Cl. 324/207.25

(57) ABSTRACT

An actuating means for actuators, in particular flaps, arranged in motor vehicles comprises a driven shaft connectable with said actuator. Further, two magnets are connected with said driven shaft in spaced relationship to the latter. For measuring the magnetic field a stationary magnetic field sensor arranged in the housing, for example, is provided. For allowing measurements of the angular positions to be taken between said two magnets a connecting element, in particular a wire, is provided for the purpose of linearization of the magnetic field, said connecting element connecting said two magnets with each other.

### BACKGROUND

1. Field of the Disclosure

The disclosure relates to an actuating means for actuators, in particular flaps, arranged in motor vehicles. The flaps are throttle flaps, swirl flaps or exhaust flaps, for example.

2. Discussion of the Background Art

For the purpose of actuating flaps, the flaps are connected with an actuating means. The actuating means comprises a driving means, such as an electric motor. Said motor generally drives a driven shaft via an intermediary gearing. Said driven shaft is directly or indirectly connected with the flap. A direct connection can be realized via a gearing, a linkage or a lever, for example. With the aid of the actuating means the flap can thus be pivoted into different positions. For example, in the case of throttle flaps not only the end positions but also the intermediate positions are of importance. It is thus necessary to determine the pivoting angle of the flap. For this purpose, it is known to provide a potentiometer in the actuating means, wherein a slider of the potentiometer is connected with a shaft of the actuating means, for example the driven shaft. The use of a potentiometer has however the drawback that said potentiometer is subject to wear and that said wear results in inaccuracies.

For performing non-contact angle sensing, it further known to connect a diametrically magnetized ring or partial ring magnet with a shaft of the actuating means, in particular with the driven shaft, and to provide a stationary magnetic field sensor, such as a Hall sensor, opposite said magnet. However, such ring magnets are expensive.

It is an object of the disclosure to provide an actuating means for actuators, in particular flaps, arranged in motor vehicles, with the aid of which an angular position can be determined in a reliable and inexpensive manner.

### SUMMARY OF THE DISCLOSURE

For the purpose of angle determination, the actuating means according to the disclosure comprises two magnets connected with the driven shaft in spaced relationship to the latter. Preferably, the driven shaft of the actuating means is a shaft disposed behind the gearing. However, said driven shaft may also be any other shaft of the actuating means. A stationary magnetic field sensor is located opposite the magnet. The magnetic field sensor, which in particular is a preferably freely programmable Hall sensor or Hall switch, is arranged in the housing of the actuating means or connected with said housing, for example. Preferably, the magnets are bar or pin-type magnets. According to the disclosure, for detecting an angular position with the aid of the magnetic field sensor, the two magnets are connected with each other via a magnetizable connecting element. Thus a linearization of the magnetic field in the angular range between the two magnets is achieved. Here, linearization of the magnetic field means that the progression of the field strength has an adequate linearity, wherein deviations from an exact linear magnetic field progression of up to 20%, preferably up to 10%, are tolerable.

By providing a magnetizable connecting element, which in a particularly preferred embodiment is a metal wire, an adequate linearization of the magnetic field in the angular range of interest of approximately 90% can be achieved. Here, deviations from an exact linear progression can be compensated for by correspondingly programming the Hall sensor, for example.

Since the magnets are connected with the driven shaft at a fixed distance to the latter, the magnets move on a circular line. It is therefore advantageous to arrange the connecting element on a circular line, too.

For accommodating the magnets, a holding element is preferably connected with the driven shaft. In a particularly preferred embodiment, the holding element is a gearwheel of a gearing provided in the actuating means. Preferably, the connecting element is also connected with the holding element. Here, the connecting element, which preferably is a wire, is advantageously arranged inside the holding element. Since the holding element is preferably made of plastic material, it is possible to inject the connecting element and/or the wire into the holding element, and/or surround them with plastic material by extrusion-coating.

In a further preferred embodiment, the magnetic field sensor is connected with a reinforcing element. Advantageously, the reinforcing element is a magnetizable and preferably cylindrical pin or wire which preferably is arranged on the rear side of the magnetic field sensor, i.e. on the side of the magnetic field sensor facing away from the magnets. Preferably, the reinforcing element extends vertically to the connecting element.

For ensuring a good measurement of the angular position, the amplitude preferably amounts to at least 20 mT.

### BRIEF DESCRIPTION OF THE DRAWINGS

A preferred embodiment of the disclosure will now be described in greater detail with reference to the drawings in which:

FIG. 1 shows a schematic exploded view of an actuating means,

FIG. 2 shows a schematic top view of a gearwheel carrying the magnets, and

FIG. 3 shows a diagram of the magnetic field strength versus the angle.

### DETAILED DESCRIPTION OF THE PREFERRED EMBODIMENT

An actuating device comprises an electric motor 10 which drives a driving shaft 12. At the driving shaft 12 a worm wheel 14 is arranged via holding elements 16. The worm wheel 14 meshes with a gearwheel 18. The gearwheel 18 is rotatably supported in a housing half 20 and permanently connected with a driven shaft (not shown). The driven shaft projects through an opening 22 from the housing half 20 and is supported in a cylindrical receiving means 26 arranged in an opposite housing half 24.

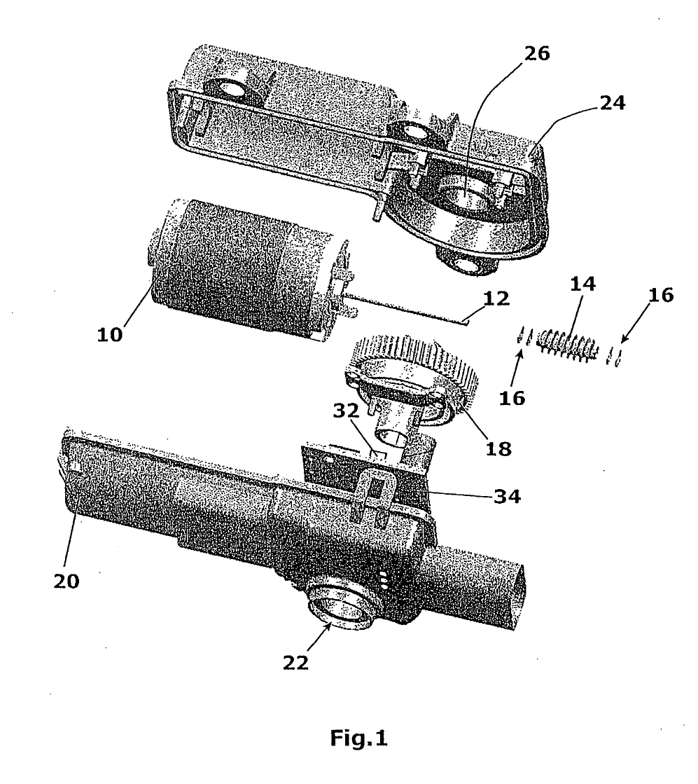

For sensing an angular position of the driven shaft, which corresponds to an angular position of the gearwheel 18 permanently connected with the driven shaft, two pin-type magnets 28,30 are arranged at an angle of α=90° to each other, for example, and connected with the gearwheel 18. Opposite the two magnets 28,30 a stationary sensor 32 (FIG. 1) is provided. The sensor 32 is arranged on a circuit board 34 which is supported in the housing half 20.

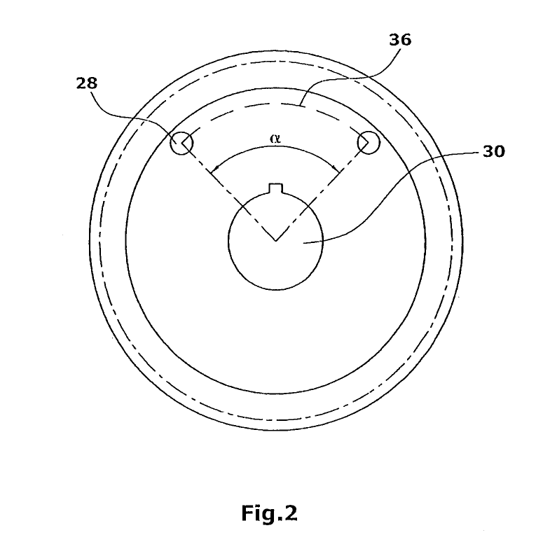

For realizing a linearization of the magnetic field within the angular range α according to the disclosure, the two magnets 28,30 are connected with each other via a wire 36 configured as a connecting element (FIG. 2). The wire 36 is arranged inside the gearwheel 18 and thus surrounded with plastic material by extrusion-coating.

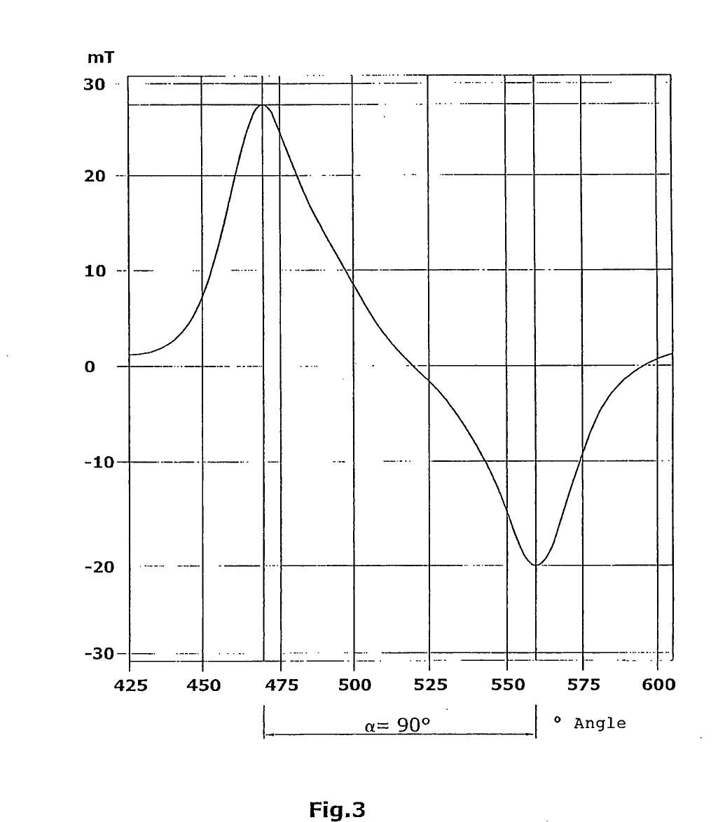

During a test, the result of which is illustrated in the diagram of FIG. 3, the angle α, i.e. the distance between the magnets, is 90°. The connecting element 36 is configured as a quarter circle and made of a metal wire with a diameter of 1.5 mm. The Hall sensor used was provided on its rear side with a reinforcing element. The reinforcing element was a cylindrical metal pin with a diameter of 3 mm and a length of 7 mm. The pin-type magnets were also of cylindrical configuration and had a diameter of 2 mm and a length of 3 mm. The Hall sensor was arranged at a distance of 3 mm to the magnets 28,30.

In the angular range of interest of α=90°, a curve shape with adequate linearity was determined. Thus, this arrangement allows different angles in the angular range a to be approached or measured in a simple manner. Since the curve extends in a range of approximately 28 mT to −20 mT, the curve also has an adequately high amplitude which allows a satisfactory measurement signal to be obtained with the Hall sensor.

Further measurements carried out have shown that the curve flattens between the two pin-type magnets when no connecting elements according to the disclosure are provided, i.e. in the illustrated embodiment at α=45°. This may lead to measuring inaccuracies and thus to an inexact angle determination. A certain reduction of flattening can be achieved by connecting the Hall sensor with a reinforcing element.

A good linearization of the curve can be obtained even without providing the connecting element, provided that a reinforcing element is arranged, by increasing the distance between the Hall sensor and the pin-type magnets. However, this has the considerable drawback that the amplitude decreases and thus the measuring accuracy is reduced. At an increase of the distance between the Hall sensor and the magnets of 6 mm, the measurement curve ranges between +10 mT and −5 mT.

In another measurement, the reinforcing element was removed. This resulted in a further decrease of the amplitude such that the measuring range lay between approximately +4 mT and −3 mT.

Proceeding from the diagram of FIG. 3, the reinforcing element was removed in a further measurement. In this case, a well linearized curve was measured. However, the amplitude decreased such that the measured value ranged between approximately +18 mT and −13 mT.

Another measurement was again based on the measuring conditions illustrated in FIG. 3, wherein however the distance between the Hall sensor and the magnets was increased to 3 mm. This resulted in a good linearization but in a considerable decrease of the amplitude such that the measuring range was reduced to a range of approximately +11 mT to −6 mT.

What is claimed is:

1. An actuating device for actuators arranged in motor vehicles, in particular flaps, such as swirl, throttle or exhaust flaps, comprising
a driven shaft connectable with an actuator,
two magnets connected with said driven shaft in spaced relationship to the latter, and
a stationary magnetic field sensor,
wherein said magnets are connected with each other via a magnetizable connecting element for the purpose of linearizing the magnetic field.

2. The actuating means according to claim 1, characterized in that the connecting element (36) is configured as a wire.

3. The actuating means according to claim 1, wherein said connecting element extends along a circular line.

4. The actuating means according to any one of claims 1-3, characterized by a holding element (18) connected with the driven shaft and carrying the magnets.

5. The actuating means according to claim 4, wherein said connecting element is connected with the holding element and is in particular arranged inside said holding element.

6. The actuating means according to claim 4 or 5, characterized in that the holding element (18) is a gearwheel of the actuating means.

7. The actuating means according to claim 1, wherein said magnetic field sensor is connected with a reinforcing element for reinforcing the magnetic field to be measured by the magnetic field sensor.

8. The actuating means according to claim 7, wherein said reinforcing element is arranged on the side of the magnetic field sensor facing away from the magnets.
